(19) United States
(12) Patent Application Publication
(10) Pub. No.: US 2014/0013397 A1
(43) Pub. Date: Jan. 9, 2014

(54) COMMUNICATION APPARATUS, COMMUNICATION METHOD, COMMUNICATION SYSTEM, AND COMPUTER PROGRAM

(71) Applicant: Sony Corporation, Minato-ku (JP)

(72) Inventor: Takehiko NAKANO, Kanagawa (JP)

(21) Appl. No.: 13/908,090

(22) Filed: Jun. 3, 2013

(30) Foreign Application Priority Data
Jul. 3, 2012 (JP) 2012-149948

(51) Int. Cl. H04L 29/06

(52) U.S. Cl. CPC H04L 63/08
USPC 726/4

(57) ABSTRACT

A communication apparatus includes: a communication section transmitting and receiving a packet encapsulating a command or a response; a transmitter confirmation section confirming whether a transmitter transmitting a command is located within a scope limited by a time-to-live value without referencing a header of a received packet; and a control section controlling a process requested by the received command or subsequent communication with the transmitter transmitting the command based on a confirmation result by the transmitter confirmation section.

### BACKGROUND

The present disclosure relates to a communication apparatus, a communication method, a communication system, and a computer program which prevent unauthorized content distribution through exchanging a decryption key for encrypted content in accordance with a predetermined mutual authentication and key exchange (AKE) algorithm and transmitting encrypted content. More specifically, the present disclosure relates to a communication apparatus, a communication method, a communication system, and a computer program which prevent unauthorized content distribution within a predetermined IP router hop count (a time-to-live (TTL) value).

Unauthorized manipulations, such as copying and tampering, of digitized content are relatively easily performed. In particular, in remote access, mechanism for protection against unauthorized use involved in content transmission, that is, copyright protection is necessary while permitting personal or home use of content. As an industry standard technology for digital content transmission protection, DTCP (Digital Transmission Content Protection) developed by the DTLA (Digital Transmission Licensing Administrator) is available.

The DTCP defines an authentication protocol for content transmission between devices, and a transmission protocol of encrypted content. In summary, the DTCP specification defines that a DTCP-compliant device shall not send easy-to-manipulate compressed content in a decrypted state to an external device, that key exchange necessary for decryption of encrypted content shall be executed in accordance with a predetermined mutual authentication and key exchange (AKE) algorithm, and that a range of devices performing key exchange by an AKE command shall be limited.

Initially, the DTCP defines content transmission over a home network through a transmission path such as IEEE 1394. Recently, as typified by DLNA (Digital Living Network Alliance), a movement to distribute digital content over an IP network even at home shifts into high gear. Accordingly, the development of DTCP-IP (DTCP mapping to IP) in which the DTCP technology is incorporated into the IP network has advanced.

The present DTCP-IP specification (DTCP Volume 1 Specification Supplement E Revision 1.31) is mainly intended to ensure home use of content. Therefore, some restrictions are imposed on transmission of DTCP commands to limit a range where an AKE procedure is performed within a household. For example, a round trip time (RTT) is limited to seven milliseconds at maximum with respect to an AKE command. Moreover, an upper limit of an IP router hop count is set. A transmitter transmitting a DTCP command sets a value of a time-to-live (TTL) field in a header of an IP packet to a value no greater than 3, and a receiver discards a received DTCP command with a TTL value greater than 3, thereby preventing the DTCP command from being sent over a long distance through three or more IP routers (for example, refer to DTCP Volume 1 Supplement E Mapping DTCP to IP, Version 1.0 (Informational Version) http://www.dtcp.com/data/info_{—}20031124_dtcp_VISE_{—}1p0.pdf/).

For example, there is proposed a communication apparatus in which, when authentication key exchange processing between DTCP-IP-compliant devices starts, a TTL value of a TCP packet transmitted first for the authentication key exchange processing is set to a permissible number in the DTCP-IP, and a message for warning constitutional trouble of the IP network is displayed when there is no response to the TCP packet (for example, refer to Japanese Unexamined Patent Application Publication No. 2007-67905).

A limit on the TTL value will be described below referring to FIGS. 10 to 12. Each of the drawings illustrates an example in which a DTCP_Sink device requesting content transmits a DTCP command, whereas a DTCP_Source device supplying content sends back a response. In each of the drawings, it is assumed that the DTCP_Sink device and the DTCP_Source device are connected to each other through an IP network with a plurality of IP routers in between. When the DTCP_Sink device transmits a DTCP command encapsulated in an IP packet, a value of a TTL field in an IP header is set to 3. Each time an IP router forwards the IP packet, the IP router decrements the value of the TTL field by one, and when the value of the TTL field reaches zero, the IP packet is discarded.

In an example illustrated in FIG. 10, since two IP routers are intervened between the DTCP_Sink device and the DTCP Source device, the DTCP command transmitted from the DTCP_Sink device arrives at the DTCP_Source device. On arrival of the DTCP command, the TTL value of the IP packet is decremented to 1. While the DTCP_Source device encapsulates a response in the IP packet, and sends back the response, the DTCP_Source device sets the value of the TTL field in the IP header to 3 in a similar manner. Since only two IP routers are intervened between the DTCP_Sink device and the DTCP_Source device, the IP packet arrives at the DTCP_Sink device.

On the other hand, in an example illustrated in FIG. 11, since three IP routers are intervened between the DTCP_Sink device and the DTCP_Source device, the TTL value of the IP packet is decremented to zero by a third IP router, and the DTCP command transmitted from the DTCP_Sink device is discarded. Therefore, the DTCP command does not arrive at the DTCP_Source device. Accordingly, the DTCP_Sink device does not receive a response from the DTCP_Source device. Moreover, also in the case where a DTCP command is transmitted from the DTCP Source device, the DTCP command does not arrive at the DTCP Sink device.

Further, in an example illustrated in FIG. 12, an unauthorized device masquerading as an authorized DTCP_Sink device sets the TTL value to 100, and transmits a DTCP command. In this case, when the IP packet passes through the third IP router, the TTL value does not reach zero, and the DTCP command reaches the DTCP_Source device. Since the TTL value of the received DTCP command is greater than 3, the DTCP Source device discards the DTCP command.

A process of checking a TTL value in an IP packet is basically performed by a DTCP application. As known in this art, a communications protocol has a stack architecture including a plurality of protocols such as TCP (Transmission Control Protocol) and IP (Internet Protocol), and the application is located in an uppermost layer of the stack architecture. Therefore, the DTCP application references a value of a TTL field in an IP protocol layer through an operating system. It is to be noted that the IP protocol layer has only a function of decrementing the value of the TTL field by one each time an IP packet passes through a router, and is not capable of checking the value of the TTL field.

However, some operating systems do not reference the TTL field in the IP header. A DTCP device operating under an environment of execution by such an operating system is not capable of discarding a DTCP command with a TTL field of which the value is set to a value exceeding the limit. In other words, “discarding of a DTCP command with a TTL value greater than 3” requested in the DTCP specification is not allowed to be executed, and as a result, a DTCP-compliant application is not allowed to be implemented.

### SUMMARY

It is desirable to provide a superior communication apparatus, a superior communication method, a superior communication system, and a superior computer program which are capable of preventing unauthorized content distribution in a preferable manner through performing command transmission and reception within a predetermined IP router hop count (TTL value).

Moreover, it is desirable to provide a superior communication apparatus, a superior communication method, a superior communication system, and a superior computer program which are capable of performing safe communication through discarding a command transmitted beyond a scope limited by the TTL value even under an environment in which a TTL value of a received packet is not allowed to be confirmed.

According to an embodiment of the disclosure, there is provided a communication section transmitting and receiving a packet encapsulating a command or a response; a transmitter confirmation section confirming whether a transmitter transmitting a command is located within a scope limited by a time-to-live value without referencing a header of a received packet; and a control section controlling a process requested by the received command or subsequent communication with the transmitter transmitting the command based on a confirmation result by the transmitter confirmation section.

In the communication apparatus according to the embodiment of the disclosure, when the communication section receives a command used in an authentication process by sequential exchange of commands, the transmitter confirmation section may not perform a process of confirming a transmitter transmitting the command.

In the communication apparatus according to the embodiment of the disclosure, when the communication section receives a command which is necessary to be confirmed, the transmitter confirmation section may perform a process of confirming a transmitter transmitting the command, the command being used in a process completed with one command and being not involved in mutual exchange of commands.

In the communication apparatus according to the embodiment of the disclosure, when the communication section transmits, within a predetermined period prior to reception of a first command, a second command to a transmitter transmitting the first command, and receives a response to the second command before a time-out period expires, the transmitter confirmation section may determine that the transmitter transmitting the first command is located within the scope limited by the time-to-live value.

In the communication apparatus according to the embodiment of the disclosure, when the communication section transmits, within a predetermined period from reception of a command, a confirmation packet with a time-to-live value set within a limit to a transmitter transmitting the command, and receives a response to the confirmation packet before a time-out period expires, the transmitter confirmation section may determine that the transmitter transmitting the command is located within the scope limited by the time-to-live value.

In this case, the communication section may transmit a command or a PING as the confirmation packet, the command or the PING being used in a process completed with one command and being not involved in mutual exchange of commands.

In the communication apparatus according to the embodiment of the disclosure, when the transmitter confirmation section confirms, during content transmission to the transmitter transmitting the command, that the transmitter transmitting the command is not located within the scope limited by the time-to-live value, the control section may stop the content transmission.

In the communication apparatus according to the embodiment of the disclosure, when the transmitter confirmation section confirms that the transmitter transmitting the command is located within the scope limited by the time-to-live value, the control section may execute a process requested by the command.

In the communication apparatus according to the embodiment of the disclosure, when the transmitter confirmation section confirms that the transmitter transmitting the command is located within the scope limited by the time-to-live value, the control section may execute a process requested by the command and sends back a response to the transmitter.

According to an embodiment of the disclosure, there is provided a communication method including: receiving a packet encapsulating a command; performing confirmation whether a transmitter transmitting the command is located within a scope limited by a time-to-live value without referencing a header of the received packet; and controlling a process requested by the received command or subsequent communication with the transmitter transmitting the command based on a result of the confirmation.

According to an embodiment of the disclosure, there is provided a communication system including: a first device setting a time-to-live value of a packet encapsulating a command to an arbitrary value, and transmitting the packet; and a second device receiving the packet and performing confirmation whether the first device is located within a scope limited by the time-to-live value without referencing a header of the packet, and then performing a process requested by the received command based on a result of the confirmation. The communication system may further include an arbitrary number of routers each forwarding the packet while decrementing the time-to-live value by one, in which the second device receives the packet through the routers.

As used herein, the term “system” refers to a logical set of a plurality of devices (or functional modules performing particular functions), and does not necessarily mean that the devices or the functional modules are housed in a single casing.

According to an embodiment of the disclosure, there is provided a non-transitory computer-readable medium storing a computer program written in a computer-readable format allowing a computer to execute: transmitting and receiving a packet encapsulating a command or a response; performing confirmation whether a transmitter transmitting a command is located within a scope limited by a time-to-live value without referencing a header of a received packet; and controlling a process requested by the received command or subsequent communication with the transmitter transmitting the command based on a result of the confirmation.

The computer program according to the embodiment of the disclosure is a computer program written in a computer-readable format so as to allow a computer to execute predetermined processing. In other words, the computer program according to the embodiment of the disclosure is installed in the computer, thereby exerting a cooperative effect on the computer and achieving functions and effects similar to those of the communication apparatus according to the embodiment of the disclosure.

In the embodiments of the disclosure, there are provided a superior communication apparatus, a superior communication method, a superior communication system, and a superior computer program which are capable of preventing unauthorized content distribution in a preferable manner through performing command transmission and reception within a predetermined IP router hop count (TTL value).

Moreover, in the embodiments of the disclosure, there are provided a superior communication apparatus, a superior communication method, a superior communication system, and a superior computer program which are capable of performing safe communication through confirming, by an separate procedure, whether a packet is transmitted from a device located within a scope limited by the TTL value even under an environment in which a TTL value of a received packet is not allowed to be confirmed.

Further objects, features, and advantageous effects of the present disclosure will become apparent from the detailed description below of embodiments of the present disclosure and drawings attached thereto.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a schematic diagram illustrating a configuration example of a communication system 100 to which an embodiment of the disclosure is applicable.

FIG. 2A is a schematic diagram illustrating a hardware configuration of a communication apparatus operating as a DTCP_Sink device 110.

FIG. 2B is a schematic diagram illustrating a functional configuration of the DTCP Sink device 110.

FIG. 3A a schematic diagram illustrating a hardware configuration of a communication apparatus operating as a DTCP_Source device 130.

FIG. 3B is a schematic diagram illustrating a functional configuration of the DTCP Source device 130.

FIG. 4A is a diagram illustrating an operation sequence (an entire sequence) of mutual authentication and key exchange with use of an AKE command.

FIG. 4B is a diagram illustrating an operation sequence of mutual authentication and key exchange (details of a challenge-response portion) with use of the AKE command.

FIG. 4C is a diagram illustrating an operation sequence of mutual authentication and key exchange (details of a RTT protocol procedure) with use of the AKE command.

FIG. 5 is a diagram for describing a mechanism for performing encrypted content transmission in accordance with DTCP-IP.

FIG. 6 is a flowchart illustrating a procedure when a DTCP device receives a DTCP command.

FIG. 7 is a flowchart illustrating another procedure when the DTCP device receives the DTCP command.

FIG. 8 is a flowchart illustrating still another procedure when the DTCP device receives the DTCP command.

FIG. 9A is a diagram illustrating a communication sequence example in which a DTCP_Source device 130 confirms whether a transmitter transmitting a DTCP command is located within a scope limited by a TTL value (in the case where the number of IP routers forwarding the DTCP command is within a limit on the TTL value).

FIG. 9B is a diagram illustrating a communication sequence example in which the DTCP_Source device 130 confirms whether a transmitter transmitting a DTCP command is located within the scope limited by the TTL value (in the case where the number of IP routers forwarding the DTCP command exceeds the limit on the TTL value).

FIG. 10 is a diagram illustrating a state where a DTCP command and a response to the DTCP command are exchanged between a DTCP_Sink device and a DTCP_Source device through IP routers.

FIG. 11 is a diagram illustrating a state where a DTCP command and a response to the DTCP command are exchanged between a DTCP_Sink device and a DTCP_Source device through IP routers.

FIG. 12 is a diagram illustrating a state where a DTCP command and a response to the DTCP command are exchanged between a DTCP_Sink device and a DTCP_Source device through IP routers.

FIG. 13 is a schematic diagram illustrating an IP packet architecture.

### DETAILED DESCRIPTION

Some embodiments of the present disclosure will be described in detail below referring to the accompanying drawings.

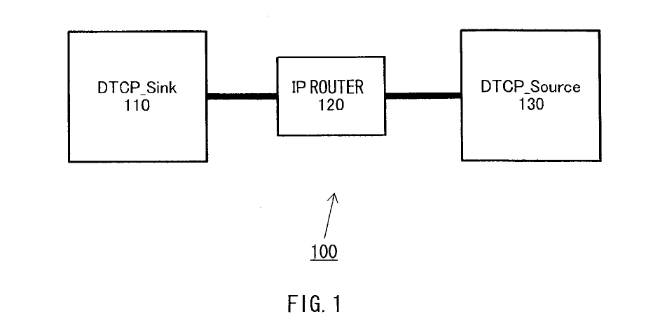

FIG. 1 schematically illustrates a configuration example of a communication system 100 to which an embodiment of the disclosure is applicable. The communication system 100 illustrated in the drawing includes a DTCP_Sink device 110 using content, and a DTCP_Source device 130 providing content. The DTCP_Sink device 110 and the DTCP_Source device 130 are connected to each other through an IP network using DTCP-IP technology.

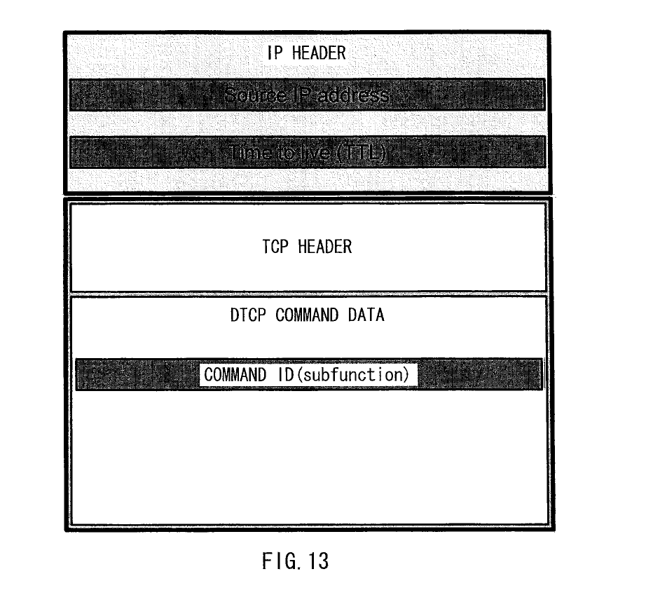

The DTCP_Sink device 110 and the DTCP_Source device 130 each transmit and receive a DTCP command and a response to the DTCP command encapsulated in an IP packet. FIG. 13 schematically illustrates an IP packet architecture used for transmission of a DTCP command. It is to be noted that fields which do not directly relates to the embodiments of the disclosure are abstracted as necessary. An IP header includes a Source IP Address field including a transmitter's IP address and a Time-to-Live field including a TTL value. Moreover, a data portion of the IP packet includes a TCP header and DTCP command data. The DTCP command data includes a command ID (subfunction) identifying the type of the DTCP command.

Moreover, in FIG. 1, a part or a whole of the IP network through which the DTCP Sink device 110 and the DTCP Source device 130 are connected to each other is a home network. One or more IP routers may be intervened between the DTCP_Sink device 110 and the DTCP_Source device 130. In FIG. 1, for simplification of the diagram, only one IP router 120 is illustrated.

Content transmission protocols implemented on the IP network, such as HTTP (Hyper Text Transfer Protocol) and RTP (Real-Time Transfer Protocol), are used to transmit encrypted content between the DTCP_Sink device 110 and the DTCP_Source device 130. For example, in the case where content is transmitted in accordance with an HTTP procedure, the DTCP_Source device 130 serves as an HTTP server, and the DTCP_Sink device 110 serves as a HTTP client, and a TCP/IP connection for the HTTP is produced to perform downloading of encrypted content (in the case where uploading is performed, the DTCP_Source device 130 serves as an HTTP client, and the DTCP_Sink device 110 serves as an HTTP server).

In the case where the DTCP_Sink device 110 and the DTCP Source device 130 are authorized DTCP devices, when the IP packet encapsulating the DTCP command or the response to the DTCP command is transmitted, a value of the TTL field in the IP header is set to 3. Moreover, when the value of the TTL in the received IP packet is set to a value greater than 3, the DTCP command is discarded.

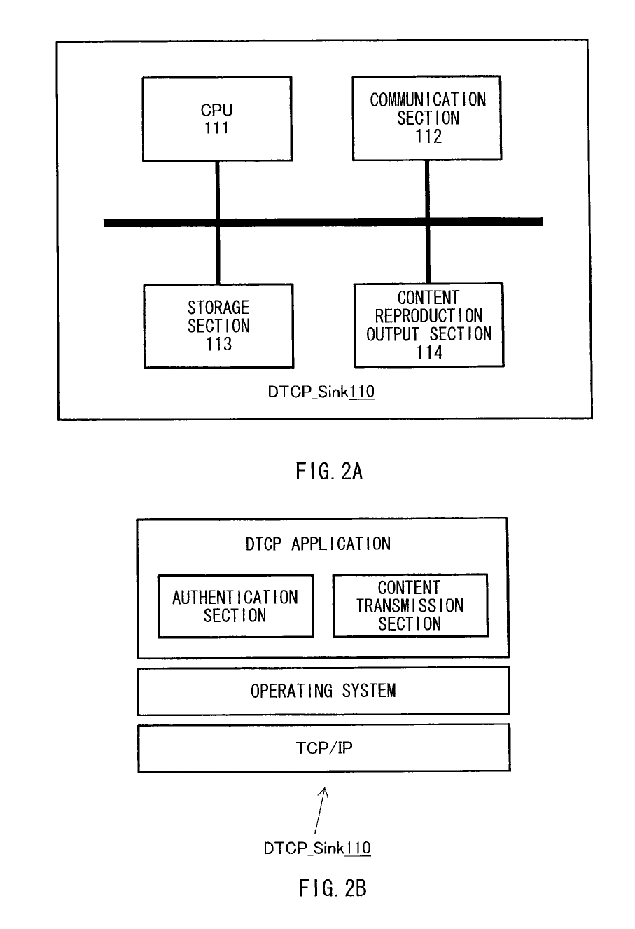

FIG. 2A schematically illustrates a hardware configuration of a communication apparatus operating as the DTCP_Sink device 110. The communication apparatus includes a CPU (Central Processing Unit) 111, a communication section 112, a storage section 113, and a content reproduction output section 114.

The CPU 111 allows the communication apparatus to operate as the DTCP_Sink device 110 through executing a DTCP application. A communications protocol processed by the CPU 111 has a stack architecture including a plurality of protocols such as TCP and IP, and the DTCP application operates as an uppermost layer under an execution environment provided by an operating system.

The communication section 112 performs a communication process with the DTCP_Source device 130 in accordance with a predetermined communications protocol such as TCP/IP under the control of the CPU 111. The storage section 113 is used to hold content obtained from the DTCP_Source device 130, installed programs, and other files. The content reproduction output section 114 reproduces a content stream received through the communication section 112 or content read from the storage section 113, and outputs the content stream or the content.

Moreover, FIG. 2B schematically illustrates a functional configuration of the DTCP_Sink device 110. The DTCP application operates in a layer above a TCP/IP layer and the operating system. The DTCP application includes an authentication section and a content transmission section. The authentication section performs authentication and key exchange together with the DTCP_Source device 130 in an AKE procedure. Moreover, the content transmission section generates an encryption key based on key information supplied from the authentication section to encrypt content and transmit the encrypted content.

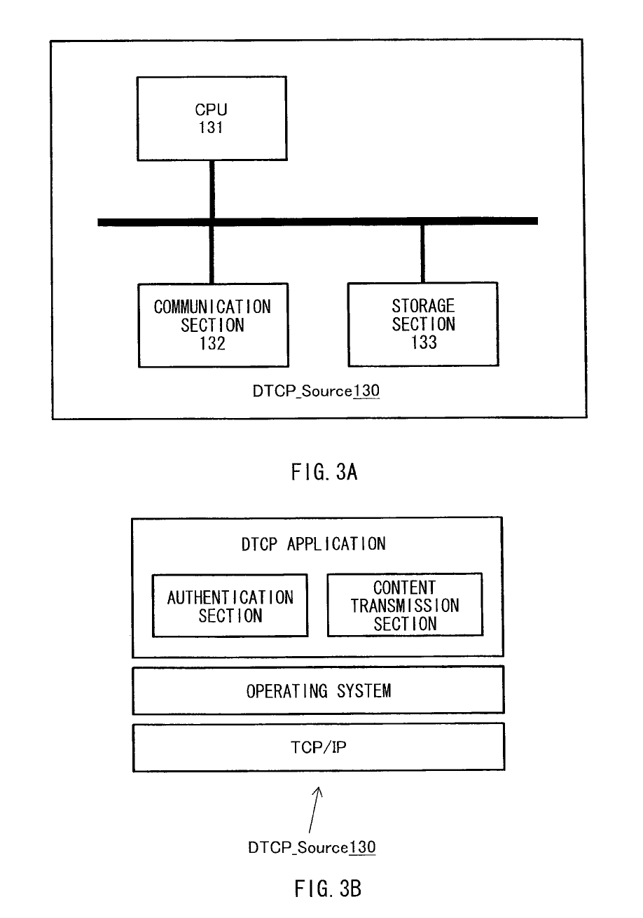

FIG. 3A schematically illustrates a hardware configuration of a communication apparatus operating as the DTCP_Source device 130. The communication apparatus includes a CPU 131, a communication section 132, and a storage section 133. The CPU 131 allows the communication apparatus to operate as the DTCP_Source device 130 through executing the DTCP application. A communications protocol processed by the CPU 131 has a stack architecture including a plurality of protocols such as TCP and IP, and the DTCP application operates as an uppermost layer under an execution environment provided by the operating system.

The communication section 132 performs a communication process with the DTCP_Sink device 110 in accordance with a predetermined communications protocol such as TCP/IP under the control of the CPU 131. The storage section 133 is used to hold content which are to be supplied to the DTCP_Sink device 110, installed programs, and other files.

The DTCP specification defines that the DTCP_Sink device 110 and the DTCP_Source device 130 shall not send unencrypted content to an external device, and that exchange of a key used for encryption and decryption of content between the DTCP_Sink device 110 and the DTCP_Source device 130 shall be performed in accordance with a predetermined mutual authentication and key exchange (AKE) algorithm.

Moreover, FIG. 3B schematically illustrates a functional configuration of the DTCP_Source device 130. The DTCP application operates in a layer above a TCP/IP layer and the operating system. The DTCP application includes an authentication section and a content transmission section. The authentication section performs authentication and key exchange together with the DTCP_Sink device 110 in the AKE procedure. The content transmission section generates an encryption key based on key information supplied from the authentication section to encrypt content and transmit the encrypted content.

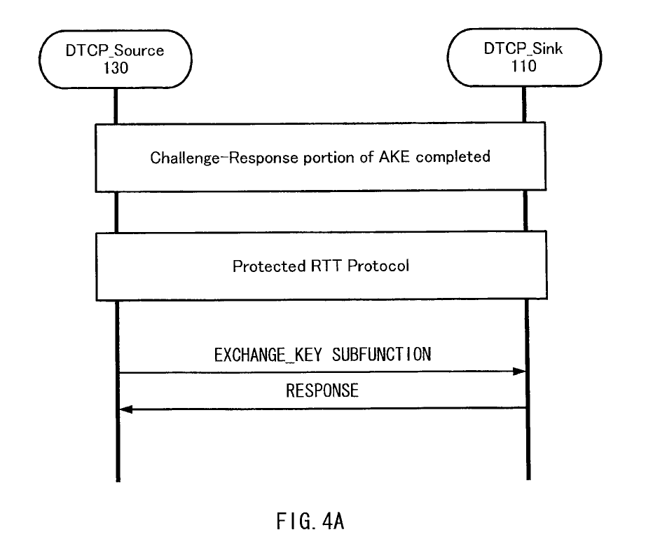

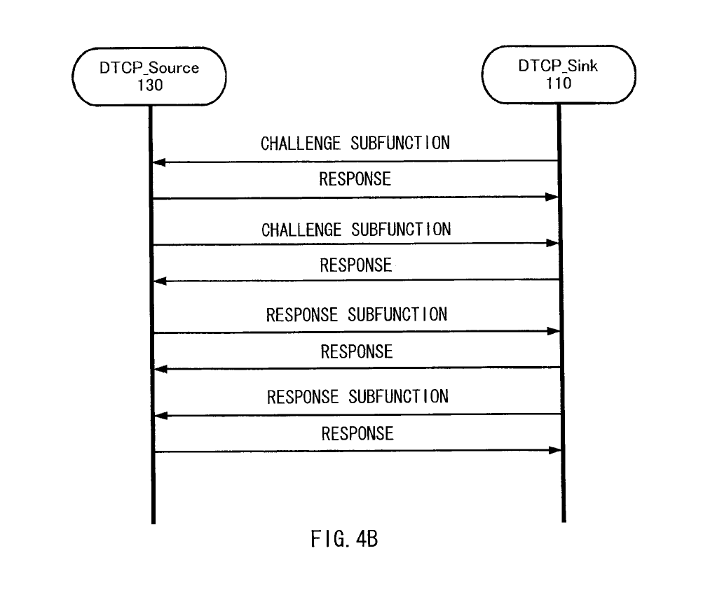

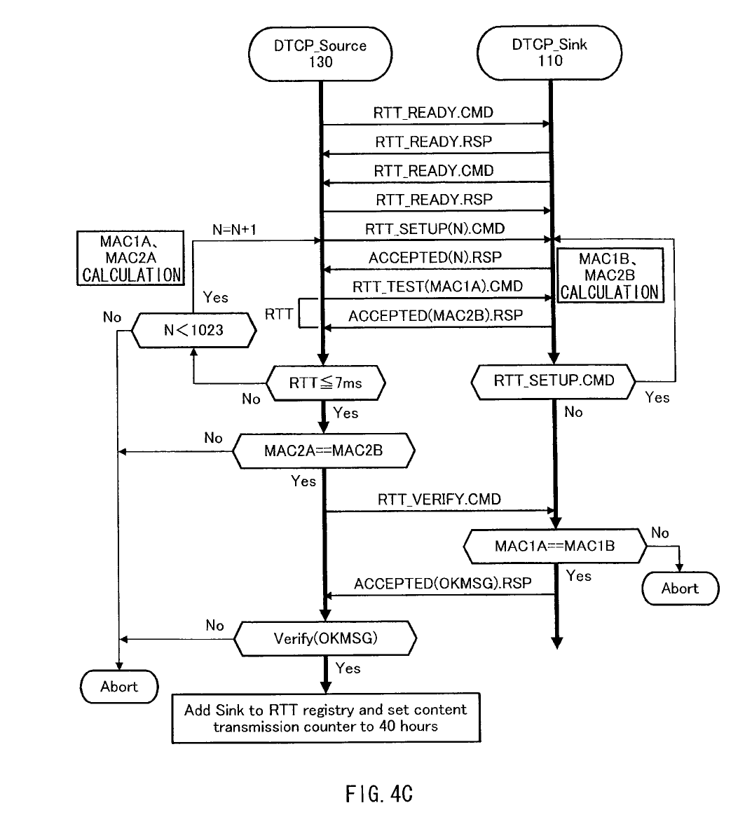

FIG. 4A illustrates an entire operation sequence (AKE procedure) of mutual authentication and key exchange with use of an AKE command. The AKE procedure is performed between the DTCP_Sink device 110 and the DTCP_Source device 130. Moreover, FIG. 4B illustrates a challenge-response portion of the AKE procedure (a challenge-response portion of AKE) in detail, and FIG. 4C illustrates a RTT protocol procedure (a Protected RTT Protocol) in detail.

In the challenge-response portion of the AKE procedure, as illustrated in FIG. 4B, first, a CHALLENGE subfunction command is transmitted from the DTCP_Sink device 110. The CHALLENGE subfunction command includes an Rx random number and an Rx certificate. Then, a response to this command is sent back from the DTCP_Source device 130. Next, a CHALLENGE subfunction command is transmitted from the DTCP_Source device 130. The CHALLENGE subfunction command includes a Tx random number and a Tx certificate. Then, a response to this command is sent back from the DTCP_Sink device 110. Next, the DTCP_Sink device 110 transmits a response subfunction command including a Tx random number, an Rx message, and an Rx signature, and the DTCP_Source device 130 sends back a response to this command. Further, the DTCP_Source device 130 transmits a response subfunction command including an Rx random number, a Tx message, and a Tx signature, and the DTCP_Sink device 110 sends back a response to this command. Each of the commands transmitted in the challenge-response portion includes a device ID which is identification information unique to a transmitter.

Basically, a TTL value (an IP router hop count) is limited in all of the DTCP commands including the above-described challenge-response portion. In other words, an authorized DTCP device sets a TTL value in a header of an IP packet to a value no greater than 3 upon transmission of a DTCP command, and when the authorized DTCP device receives an IP packet with a TTL value greater than 3, the DTCP command is discarded.

In the RTT protocol procedure, as illustrated in FIG. 4C, first, the DTCP_Source device 130 transmits a command “RTT_READY.CMD”, and the DTCP_Sink device 110 sends back a response “RTT_READY.RSP”, and transmits a command “RTT_READY.CMD”, and then the DTCP_Source device 130 sends back a response “RTT_READY.RSP”. Thus, the RTT protocol procedure (Protected RTT Protocol) starts. At this time, while the DTCP_Source device 130 calculates two kinds of message authentication codes MAC1A and MAC2A, the DTCP_Sink device 110 calculates two kinds of message authentication codes MAC1B and MAC2B by a calculation method similar to a calculation method in the DTCP_Source device 130. Then, the DTCP_Source device 130 transmits a variable N in response to a command “RTT_SETUP(N).CMD”, and the DTCP_Sink device 110 sends back a response “ACCEPTED(N).RSP” to this command. The DTCP_Source device 130 and the DTCP_Sink device 110 both prepare a message authentication code for the variable N transmitted in this case.

Next, the DTCP_Source device 130 transmits an RTT measurement command “RTT TEST(MAC1A).CMD”, and the DTCP_Sink device 110 sends back a response “ACCEPTED(MAC2B).RSP” to this command. Then, the DTCP_Source device 130 performs a check of whether a round trip time (RTT) from sending the RTT measurement command to receiving a response to this command is equal to or less than a predetermined threshold value (seven milliseconds), that is, an RTT check.

When the RTT exceeds the threshold value, the DTCP_Source device 130 further checks whether the number of attempts exceeds 1023. When the number of attempts does not exceed 1023, the DTCP_Source device 130 increments “N” by one, and then prepares a message authentication code corresponding to the new “N” and transmits a RTT_SETUP(N) command. The DTCP_Sink device 110 also prepares a message authentication code corresponding to the new “N”, and transmits an ACCEPTED(N) response. Thus, transmission of the RTT measurement command and a response are repeated between the DTCP_Source device 130 and the DTCP_Sink device 110. Moreover, when the number of attempts exceeds 1023, the DTCP_Source device 130 aborts this authentication procedure.

On the other hand, when the RTT is equal to or less than the threshold value, the DTCP_Source device 130 further checks whether the received message authentication code MAC2B in the ACCEPTED(MAC2B).RSP matches the message authentication code MAC2A generated by itself. When the message authentication code MAC2B does not match the message authentication code MAC2A, the DTCP_Source device 130 aborts the authentication procedure.

When the message authentication codes MAC2A and MAC2B match each other, the DTCP_Source device 130 transmits a RTT verification command “RTT_VERIFY.CMD”. The DTCP_Sink device 110 responds to this command, and checks whether the received message authentication code MAC1A in an RTT_TEST(MAC1A).CMD matches the message authentication code MAC1B generated by itself. When the message authentication code MAC1A does not match the message authentication code MAC1B, the DTCP_Sink device 110 aborts the authentication procedure, and when the message authentication code MAC1A matches the message authentication code MAC1B, the DTCP_Sink device 110 sends back an ACCEPTED(OKMSG).RSP.

When the DTCP_Source device 130 receives the ACCEPTED(OKMSG).RSP from the DTCP_Sink device 110, the DTCP_Source device 130 verifies a message OKMSG included in the ACCEPTED(OKMSG).RSP. When verification of the message OKMSG succeeds, a source device adds a sink device to an RTT registry, and sets a content transmission counter to 40 hours. Moreover, when verification of the message OKMSG fails, the DTCP_Source device 130 aborts this authentication procedure.

After that, as illustrated in FIG. 4A, an EXCHANGE_KEY subfunction command is transmitted from the DTCP_Source device 130, and a response to this command is sent back from the DTCP_Sink device 110.

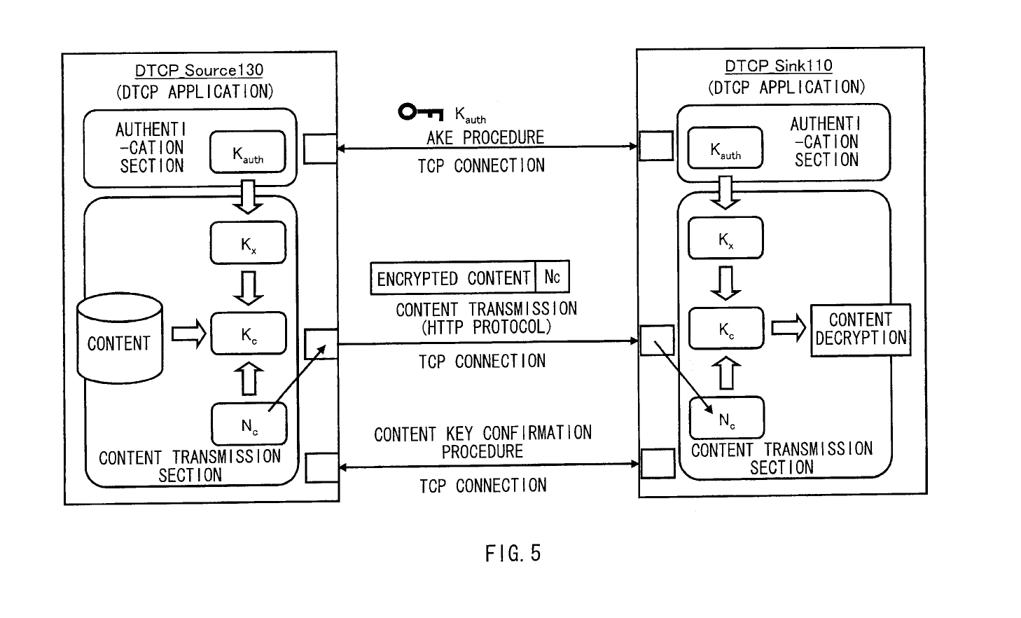

FIG. 5 illustrates a mechanism for performing encrypted content transmission in accordance with DTCP-IP between the DTCP_Sink device 110 and the DTCP_Source device 130.

The DTCP_Sink device 110 and the DTCP_Source device 130 first establish one TCP/IP connection, and perform the above-described AKE procedure. When the AKE procedure succeeds, the DTCP_Source device 130 generates an exchange key Kₓ serving as a seed of a content key IC, and encrypts the exchange key Kₓ with an authentication key Kₐᵤₜₕ, and transmits the encrypted exchange key Kₓ to the DTCP Sink device 110.

Then, after an authentication and key exchange procedure in accordance with the AKE procedure is completed between the DTCP_Sink device 110 and the DTCP_Source device 130, content transmission starts with use of protocols such as HTTP (Hyper Text Transfer Protocol) and RTP (Real Time Protocol). In an example illustrated in the drawing, content transmission is performed in accordance with a procedure of the HTTP. At this time, a TCP/IP connection for the HTTP is made, in addition to the TCP/IP connection for the AKE procedure.

There are two methods of performing content transmission in accordance with the HTTP protocol, that is, a download method in which the DTCP_Sink device 110 requests content from the DTCP_Source device 130, and an upload method in which the DTCP_Source device 130 pushes content to the DTCP_Sink device 110. In the download method, the DTCP_Sink device 110 serving as an HTTP client requests content from the DTCP_Source device 130 serving as an HTTP server at an HTTP request using, for example, an HTTP GET method, and the DTCP_Source device 130 transmits the requested content as an HTTP response. In the upload method, the DTCP_Source device 130 serving as an HTTP client starts transmission with the DTCP_Sink device 110 serving as an HTTP server at an HTTP request using, for example, an HTTP POST method.

Data transmitted from the DTCP_Source device 130 is data in which content is encrypted by the source device with use of a key shared after performing AKE authentication. More specifically, the DTCP_Source device 130 generates a nonce N_{c} with use of random numbers, and generates a content key K_{c} corresponding to the exchange key Kₓ, the nonce N_{c}, and an encryption mode. Then, the DTCP_Source device 130 encrypts the content requested by the DTCP_Sink device 110 with use of the content key K_{c}, and transmits, over a TCP stream, a packet which encapsulates a payload including the encrypted content, and a header including the nonce N_{c} and information of the encryption mode.

When the DTCP_Sink device 110 receives each IP packet from the DTCP_Source device 130, the DTCP_Sink device 110 assembles this IP packet into a TCP stream. Then, the DTCP_Sink device 110 calculates the content key K_{c} with use of the nonce N_{c} and the exchange key Kₓ extracted from the TCP stream. Thus, the DTCP_Sink device 110 is allowed to decrypt the encrypted content with use of the content key K_{c}. When content transmission using the HTTP protocol is completed in such a manner, for example, the DTCP_Sink device 110 cuts the TCP connection used for the content transmission, as necessary.

It is to be noted that the DTCP-IP defines that the exchange key Kₓ shall be discarded before a continuous unused time exceeds a predetermined period (for example, 2 hours). It is because when a same encryption key is used continuously, a risk of decryption of the key is increased. In other words, the DTCP_Source device 130 updates the nonce N_{c} and the content key K_{c} every 128 MB of content.

On the other hand, when the DTCP_Sink device 110 is not allowed to obtain a latest exchange key Kₓ, the encrypted content is not available. Therefore, the DTCP_Sink device 110 further establishes a TCP connection for content key confirmation, in addition to the TCP connection for content transmission, and performs a procedure for content key confirmation with respect to the DTCP_Source device 130.

For example, content key confirmation is defined in a specification “DTCP-IP Volume 1 Supplement Section V1 SE.8.6”. In the specification, the DTCP_Sink device 110 confirms a content key corresponding to a present nonce N_{c} with use of a CONT_KEY_CONF subfunction.

Next, compliance with a limit on the TTL value defined in the DTCP-IP specification will be studied below.

It is defined that, when an authorized DTCP device transmits an IP packet encapsulating a DTCP command or a response to the DTCP command, the authorized DTCP device shall set a value of a TTL field in an IP header to 3, and when a value of a TTL field in a received IP packet is set to a value greater than 3, the authorized DTCP device shall discard the IP packet. The purpose is to prevent exchange of DTCP commands through three or more routers.

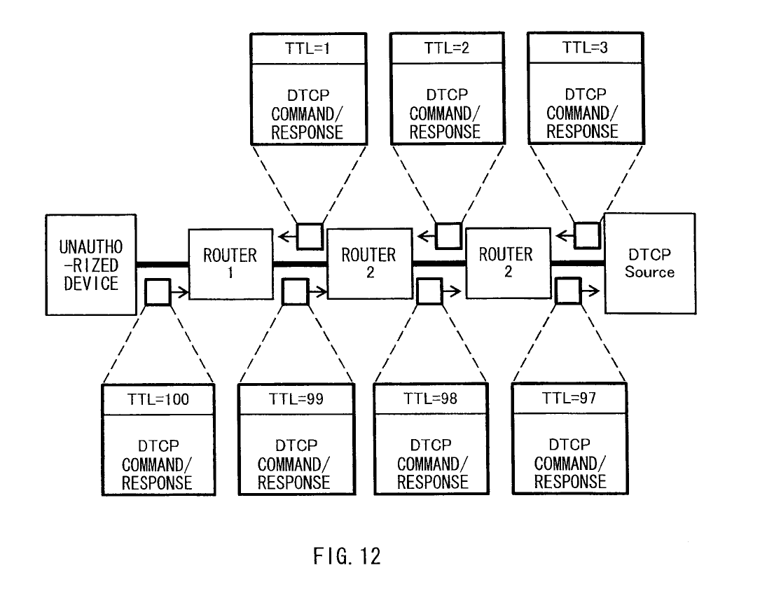

As illustrated in FIG. 12, when a DTCP command in which the value of the TTL field is set to a value greater than 3 is received, it is necessary to discard the DTCP command. This process is performed by the DTCP application. However, some operating systems do not reference the TTL field in the IP header, and it is feared that “discarding of a DTCP command with a TTL value greater than 3” requested in the DTCP specification may not be executed. As a result, the DTCP application is not allowed to be implemented.

In the case of a process which is completed through properly exchanging DTCP commands from both the DTCP devices, even if an authorized DTCP device is not allowed to reference a TTL field of an IP packet received from a transmitter, the authorized DTCP device sets the value of the TTL field to a value no greater than 3, and transmits a DTCP command. Therefore, exchange of DTCP commands through three or more routers is preventable.

For example, in a communication sequence illustrated in FIGS. 4A, 4B, and 4C, even if the DTCP_Source device 130 is not allowed to confirm a value of a TTL field of a CHALLENGE subfunction command received from the DTCP_Sink device 110, upon transmission of a CHALLENGE subfunction command from the DTCP_Source device 130, the DTCP_Source device 130 sets the value of the TTL field to a value no greater than 3 in the header of the IP packet, the command does not reach the DTCP_Sink device 110 located at a distance through three or more routers, and further exchange of DTCP commands is preventable accordingly.

It is to be noted that, in addition to the CHALLENGE subfunction command, commands such as RESPONSE, RESPONSE2, EXCHANGE_KEY, SRM, RTT_READY, RTT_SETUP, RTT_TEST, RTT_VERIFY, MV_INITIATE, CAPABILITY_EXCHANGE, MV_EXCHANGE_KEY, and RA_REGISTER, of which meanings and roles will not be described in detail, are also used in the process which is completed through properly exchanging commands from both the DTCP devices (a command process in which an authentication process is performed by sequential exchange of commands, and which is not a one-shot command process). Therefore, even if the authorized DTCP device is not allowed to reference the TTL field of the IP packet received from a transmitter, the authorized DTCP device sets the value of the TTL field to a value no greater than 3, and transmits a DTCP command. Accordingly, exchange of DTCP commands through three or more routers is preventable in a similar manner.

On the other hand, in the case where a process is completed with one DTCP command, even if a DTCP device which is not allowed to reference the value of the TTL field of the received IP packet sets the value of the TTL field to a value no greater than 3, exchange of the DTCP command with a device connected to the DTCP device through three or more routers is not preventable.

For example, as described above, with updating of the nonce N_{c} in the DTCP_Source device 130, the DTCP_Sink device 110 transmits the CONT_KEY_CONF subfunction command for content key confirmation. When the DTCP_Source device 130 receives the CONT_KEY_CONF subfunction command, the process is completed, and further exchange of DTCP commands is not performed. Therefore, when the TTL field is not allowed to be referenced, whether a transmitter which transmits the CONT_KEY_CONF subfunction command is located at a distance through three or more routers is not determined.

It is to be noted that, in addition to the CONT_KEY CONF subfunction command, commands such as CONTENT_KEY_REQ and CAPABILITY_REQ, of which meanings and roles will not be described in detail, are used in a process completed with one DTCP command (that is, the one-shot command process), and exchange of DTCP commands between DTCP devices is not performed. Therefore, a DTCP device which is not allowed to reference the value of the TTL field of the received IP packet is not allowed to prevent exchange of DTCP commands with a device connected to the DTCP device with three or more routers in between in a similar manner.

Therefore, in the embodiment, in the case where an authorized DTCP device completes a process with one received DTCP command, the authorized DTCP device performs safe communication through confirming, by an separate procedure, whether a packet is transmitted from a device located within a scope limited by the TTL value.

The separate procedure herein specifically refers to a process in which a DTCP device receiving a DTCP command from a transmitter sets a value of a TTL field to 3 and transmits a DTCP command to the transmitter, and then confirms, based on a response from the transmitter, whether the transmitter is located within the scope limited by the TTL value.

Hereinafter, for convenience of description, a received packet which is necessary to be separately confirmed whether a transmitter transmitting the packet is located within the scope limited by the TTL value is referred to as “to-be-confirmed packet”, and a packet which is transmitted to separately confirm whether the transmitter is located within the scope limited by the TTL value is referred to as “confirmation packet”.

In particular, a packet encapsulating a DTCP command which is used in a one-shot command process is a to-be-confirmed packet. Specific examples of the DTCP command which is used in the one-shot process include commands “CONT_KEY_CONF”, “CONTENT_KEY_REQ”, and “CAPABILITY_{—} REQ” transmitted from a sink device and commands “AKE Status”, “AKE_CANCEL”, and “MV_CANCEL” transmitted from both the sink device and a source device, though meanings and roles of the respective commands will not be described in detail.

It is to be noted that a packet encapsulating a DTCP command as a command process which is not a one-shot command process and in which an authentication process is performed by sequential exchange of commands may be treated as a to-be-confirmed packet. However, during a process of transmitting commands between the sink device and the source device, whether the transmitter is located within the scope limited by the TTL is confirmed; therefore, it is not necessary to additionally transmit the confirmation command.

Moreover, the above-described DTCP command which is the one-shot command process may be used as the confirmation packet through setting a TTL value in an IP header of the DTCP command to a predetermined value. However, a DTCP command which is applicable as a confirmation packet is changed depending on which of the source device or the sink device performs an separate procedure for confirmation (the CONT_KEY_CONF, the CONTENT_KEY_REQ, and the CAPABILITY_REQ transmitted only from the sink device are not applicable as confirmation packets of the source device). Alternatively, a known PING used for reachability confirmation in an IP network may be applicable as a confirmation packet.

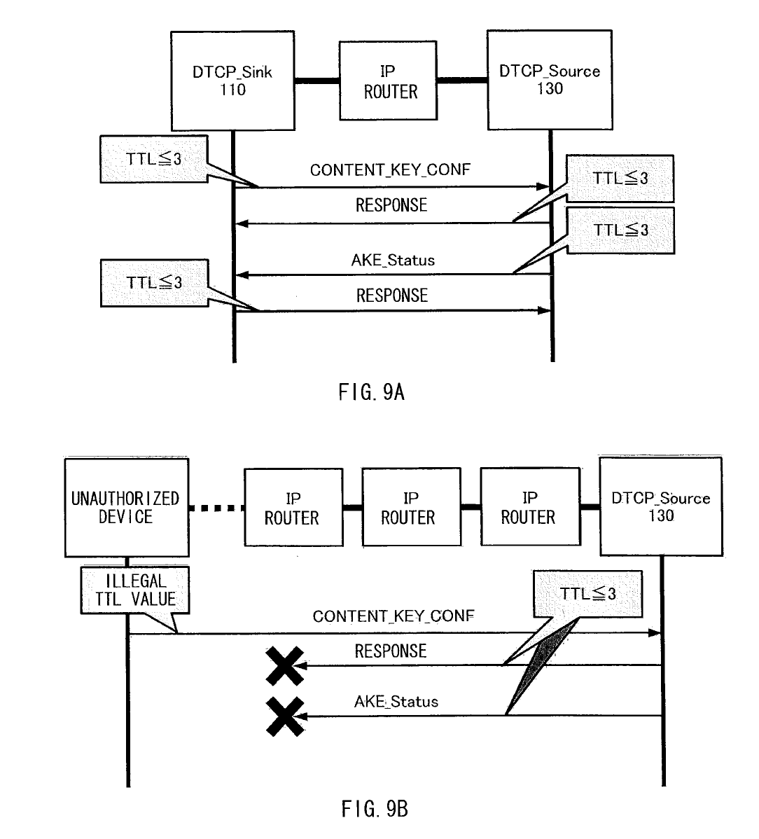

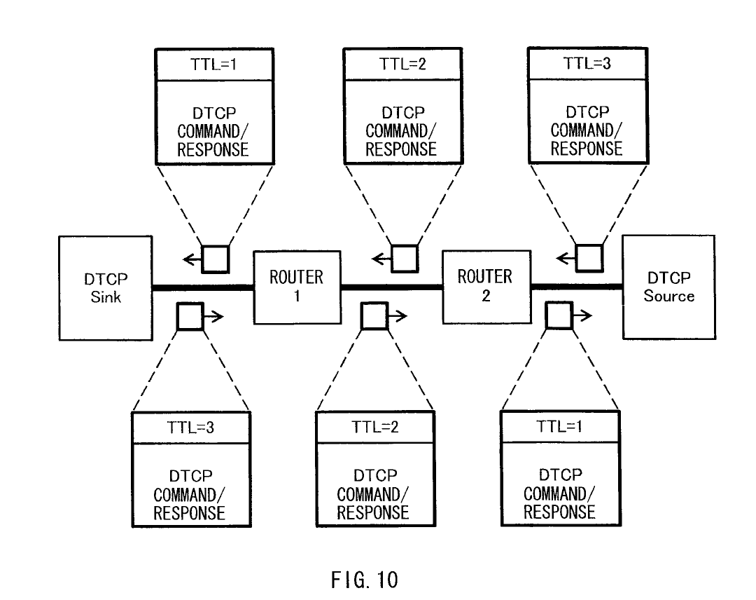

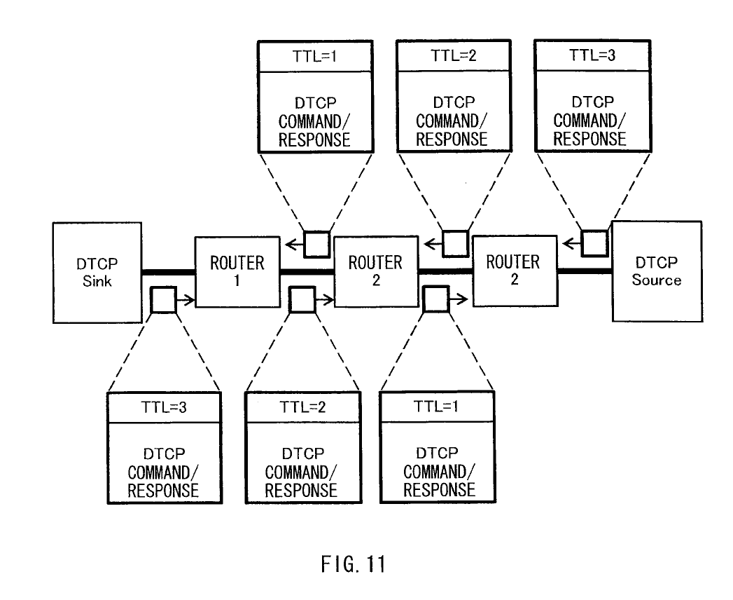

FIGS. 9A and 9B illustrate a communication sequence example in which the DTCP_Source device 130 receiving the CONT KEY_CONF subfunction command confirms, with use of an AKE Status command as a confirmation packet, whether a transmitter transmitting a DTCP command is located within the scope limited by the TTL value. The AKE Status command is intrinsically a DTCP command used to confirm capability or the like of the transmitter.

The DTCP_Source device 130 sets the value of the TTL field to 3, and transmits the AKE Status command to the transmitter transmitting the CONT_KEY_CONF subfunction command. In an example illustrated in FIG. 9A, the transmitter transmitting the CONT_KEY_CONF subfunction command is the DTCP_Sink device 110 connected to the DTCP_Source device 130 with one router in between, and receives the AKE Status command. Therefore, the DTCP_Source device 130 confirms that the DTCP_Sink device 110 is located within the scope limited by the TTL value through receiving a response from the DTCP_Sink device 110.

On the other hand, in an example illustrated in FIG. 9B, an unauthorized device connected to the DTCP_Source device 130 with three or more routers in between sets the value of the TTL field to a value greater than 3, and transmits the CONT_KEY_CONF subfunction command. In this case, the AKE Status command of which the value of the TTL field is set to 3 is transmitted from the DTCP Source_device 130, and the value of the TTL field of the AKE Status command is decremented to 0 by an IP router intervened between the DTCP_Source device 130 and the unauthorized device, and the AKE Status command does not reach the unauthorized device. Therefore, the DTCP_Source device 130 does not receive a response to the AKE Status command within a predetermined period. Accordingly, it is determined that the transmitter transmitting the CONT_KEY_CONF subfunction command is not located within the scope limited by the TTL value.

It is necessary for the DTCP device to confirm whether a transmitter transmitting a to-be-confirmed packet is located within the scope limited by the TTL value within a predetermined period T prior to and subsequent to the time of receiving the to-be-confirmed packet. The predetermined period T herein is based on a minimum value necessary to perform a process on a response from the transmitter located within the scope limited by the TTL value from the time of transmitting a packet by the DTCP device. The period T is limited to a predetermined period, because after a lapse of the period T, the transmitter may move from a location within the scope limited by the TTL value to a location out of the scope limited by the TTL value.

In the case where the DTCP device has confirmed, within the predetermined period T prior to the time of receiving the to-be-confirmed packet from a transmitter, that the same transmitter is located within the scope limited by the TTL value, it is not necessary for the DTCP device to transmit a confirmation packet after receiving the to-be-confirmed packet. For example, in the case where the DTCP device has transmitted a DTCP command of which the value of the TTL field is set to a value no greater than 3 to the same transmitter and has received a response to the DTCP command within the predetermined period T, the DTCP device has already confirmed that the transmitter transmitting the to-be-confirmed packet is located within the scope limited by the TTL value.

Moreover, when the DTCP device receives a to-be-confirmed packet from a transmitter which has not yet been confirmed in the above-described manner, as a separate procedure, a confirmation packet is transmitted within the predetermined period T from the time of receiving the to-be-confirmed packet. Then, when a response is received before a time-out period for the command expires, the DTCP device confirms that the transmitter transmitting the to-be-confirmed packet is located within the scope limited by the TTL value.

The DTCP device is supposed to confirm that the transmitter is located within the scope limited by the TTL value before processing a DTCP command included in the received to-be-confirmed packet. However, in a process which may be stopped when it is confirmed that the transmitter is located within the scope limited by the TTL value while the DTCP command is temporarily accepted, the transmitter may be confirmed separately from a process requested by the DTCP command.

A main purpose of the DTCP technology is to transmit content. For example, the DTCP_Source device 130 confirms whether the transmitter is located within the scope limited by the TTL value immediately after receiving the DTCP command. Then, when the transmitter is located out of the scope limited by the TTL value, the DTCP_Source device 130 is allowed to stop content transmission, thereby limiting content transmission through a predetermined number (three) or more of IP routers.

Moreover, in the case where the DTCP command included in the received to-be-confirmed packet requests a certain process, the DTCP device may perform a requested process after confirming, by a separate procedure, that the transmitter is located within the scope limited by the TTL value.

Further, the DTCP device may confirm, by a separate procedure, that the transmitter is located within the scope limited by the TTL value before sending back a response to the DTCP command included in the received to-be-confirmed packet, and then may send back a response to the DTCP command.

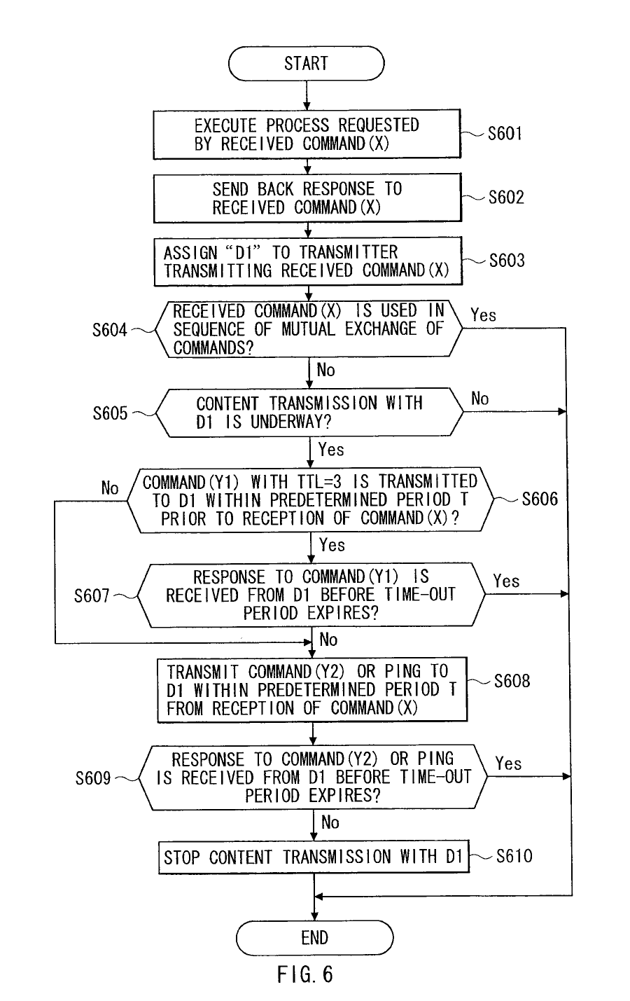

FIG. 6 illustrates, in a flowchart form, a process procedure when the DTCP device such as the DTCP_Sink device 110 or the DTCP_Source device 130 receives a DTCP command. The process procedure in the drawing is executed basically by the DTCP application, and the TTL field in the header of the received IP packet is not allowed to be referenced; therefore, a separate procedure for confirming whether the transmitter is located within the scope limited by the TTL value is executed.

The DTCP application executes a process requested by a received DTCP command (X) (step S601). The DTCP application sends back a response to the received DTCP command (X) (step S602), and assigns “D1” to a transmitter transmitting the DTCP command (X), and retains the transmitter as D1 and its IP address in memory (step S603).

Then, the DTCP application checks whether the received DTCP command (X) is used in a command process in which an authentication process is performed by sequential exchange of commands, and which is not a one-shot command process (step S604).

In the case where the received DTCP command (X) is used in the command process which is not the one-shot command process (Yes in step S604), a transmitter located within the scope limited by the TTL value is confirmed by the authentication process by sequential exchange of commands. In other words, the separate procedure for confirming whether the transmitter D1 is located within the scope limited by the TTL value is not necessary; therefore, the DTCP application completes a routine of this process.

Next, the DTCP application checks whether content transmission with the transmitter D1 is underway (step S605). In the case where content transmission with the transmitter D1 is not underway (No in step S605), the separate procedure for confirming whether the transmitter D1 is located within the scope limited by the TTL value is not necessary; therefore, the DTCP application completes the routine of this process.

Next, the DTCP application checks whether a DTCP command (Y1) with a TTL value within the limit is transmitted to the transmitter D1 within a predetermined period T prior to reception of the DTCP command (X) (step S606). In the case where the DTCP command (Y1) with a TTL value no greater than 3 is transmitted to the transmitter D1 within the predetermined period T (Yes in step S606), the DTCP application further checks whether a response to the DTCP command (Y1) is received from the transmitter D1 within a time-out period (step S607). Whether a transmitter transmitting the response to the DTCP command (Y1) is the transmitter D1 is confirmed by Source IP address matching. Moreover, whether the response corresponds to the DTCP command (Y1) is confirmed by whether a command ID (subfunction) value written in DTCP command data of the DTCP command (Y1) matches a command ID value written in DTCP command data of the response.

In the case where the response to the DTCP command (Y1) is received from the transmitter D1 within the time-out period (Yes in step S607), it is confirmed that the transmitter D1 is located within the scope limited by the TTL value. Accordingly, the separate procedure for confirming whether the transmitter D1 is located within the scope limited by the TTL value is not necessary; therefore, the DTCP application completes the routine of this process.

On the other hand, in the case where content transmission with the transmitter D1 is underway (Yes in step S605), and the DTCP command (Y1) with a TTL value no greater than 3 is not transmitted to the transmitter D1 within the predetermined period T (No in step S606), or the response to the DTCP command (Y1) is not received from the transmitter D1 within the time-out period (No in step S607), it is confirmed that a received packet (X) is a to-be-confirmed packet. In this case, a separate process for confirming whether the transmitter D1 is located within the scope limited by the TTL value is necessary.

Therefore, the DTCP application transmits a confirmation packet to the transmitter D1 within the predetermined period T from reception of the DTCP command (X) (step S608). The confirmation packet is a DTCP command (Y2) or a PING used in a one-shot command process.

Then, the DTCP application checks whether a response to the confirmation command, that is, the DTCP command (Y2) or the PING is received from the transmitter D1 within the time-out period (step S609). In this case, whether a transmitter transmitting the response to the DTCP command (Y2) or the PING is the transmitter D1 is confirmed by Source IP address matching.

In the case where the response to the DTCP command (Y2) or the PING is received from the transmitter D1 within the time-out period (Yes in step S609), it is confirmed that the transmitter DI is located within the scope limited by the TTL value. In this case, the DTCP application completes the routine of this process, and continues content transmission with the transmitter D1.

On the other hand, in the case where the response to the DTCP command (Y2) or the PING is not received from the transmitter D1 within the time-out period (No in step S609), it is confirmed that the transmitter D1 is not located within the scope limited by the TTL value. In this case, the DTCP application stops content transmission with the transmitter D1 (step S610), and completes the routine of this process.

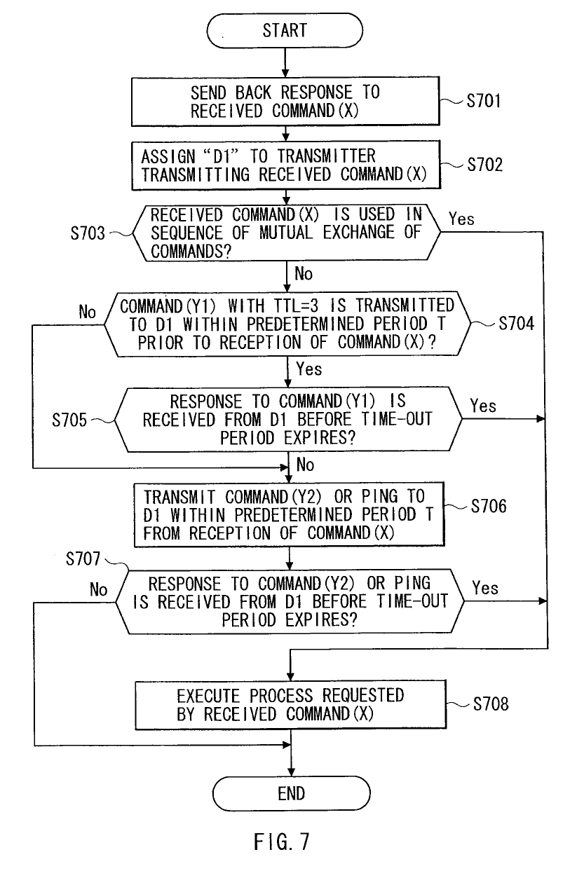

Moreover, FIG. 7 illustrates, in a flowchart form, another example of the process procedure executed when the DTCP device such as the DTCP Sink device 110 or the DTCP Source device 130 receives a DTCP command. The process procedure in the drawing is basically executed by the DTCP application, and the TTL field in the header of the received IP packet is not allowed to be referenced; therefore, the separate procedure for confirming whether the transmitter is located within the scope limited by the TTL value is executed.

When the DTCP application receives the DTCP command (X), the DTCP application sends back a response to the DTCP command (X) (step S701), and assigns “D1” to a transmitter transmitting the DTCP command (X), and retains the transmitter as D1 and its IP address in memory (step S702).

Then, the DTCP application checks whether the received DTCP command (X) is used in a command process in which an authentication process is performed by sequential exchange of commands, and which is not a one-shot command process (step S703).

In the case where the received DTCP command (X) is used in the command process which is not the one-shot command process (Yes in step S703), a transmitter located within the scope limited by the TTL value is confirmed by the authentication process by sequential exchange of commands. Therefore, the DTCP application executes a process requested by the received DTCP command (X) (step S708), and completes a routine of this process.

On the other hand, in the case where the received DTCP command (X) is used in the one-shot command process (No in step S703), the DTCP application checks whether the DTCP command (Y1) with a TTL value within the limit is transmitted to the transmitter D1 within a predetermined period prior to reception of the DTCP command (X) (step S704).

In this case, in the case where the DTCP command (Y1) with a TTL value no greater than 3 is transmitted to the transmitter D1 within the predetermined period T (Yes in step S704), the DTCP application further checks whether a response to the DTCP command (Y1) is received from the transmitter D1 within a time-out period (step S705). In this case, whether a transmitter transmitting the response to the DTCP command (Y1) is the transmitter D1 is confirmed by Source IP address matching. Moreover, whether the response corresponds to the DTCP command (Y1) is confirmed by whether a command ID (subfunction) value written in DTCP command data of the DTCP command (Y1) matches a command ID value written in DTCP command data of the response.

In the case where the response to the DTCP command (Y1) is received from the transmitter D1 within the time-out period (Yes in step S705), it is confirmed that the transmitter D1 is located within the scope limited by the TTL value. Accordingly, the separate procedure for confirming whether the transmitter D1 is located within the scope limited by the TTL value is not necessary; therefore, the DTCP application executes a process requested by the received DTCP command (X) (step S708), and completes the routine of this process.

Moreover, in the case where the DTCP command (Y1) with a TTL value no greater than 3 is not transmitted to the transmitter D1 within the predetermined period T (No in step S704), or in the case where the response to the DTCP command (Y1) is not received from the transmitter D1 within the time-out period (No in step S705), it is confirmed that the received packet (X) is a to-be-confirmed packet. In this case, the separate process for confirming whether the transmitter D1 is located within the scope limited by the TTL value is necessary.

Therefore, the DTCP application transmits, as a confirmation packet, the DTCP command (Y2) or the PING which is used in a one-shot command process to the transmitter DI within the predetermined period T from reception of the DTCP command (X) (step S706). Then, the DTCP application checks whether a response to the confirmation packet, that is, the DTCP command (Y2) or the PING is received from the transmitter D1 within the time-out period (step S707). In this case, whether a transmitter transmitting the response to the DTCP command (Y2) or the PING is the transmitter DI is confirmed by Source IP address matching.

In the case where the response to the DTCP command (Y2) or the PING is received from the transmitter D1 within the time-out period (Yes in step S707), it is confirmed that the transmitter D1 is located within the scope limited by the TTL value. In this case, the DTCP application executes the process requested by the received DTCP command (X) (step S708), and completes the routine of this process.

On the other hand, in the case where the response to the DTCP command (Y2) or the PING is not received from the transmitter D1 within the time-out period (No in step S707), it is confirmed that the transmitter D1 is not located within the scope limited by the TTL value. In this case, the DTCP application completes the routine of this process without executing the process requested by the received DTCP command (X).

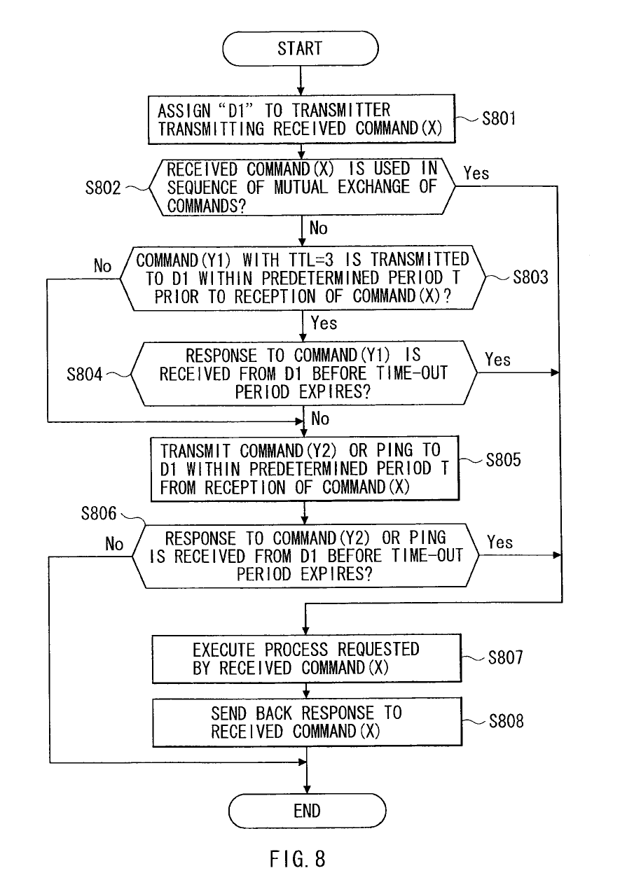

Further, FIG. 8 illustrates, in a flowchart form, still another example of the process procedure executed when the DTCP device such as the DTCP_Sink device 110 or the DTCP_Source device 130 receives a DTCP command. The process procedure in the drawing is basically executed by the DTCP application, and the TTL field in the header of the received IP packet is not allowed to be referenced; therefore, the separate procedure for confirming whether the transmitter is located within the scope limited by the TTL value is executed.

When the DTCP application receives the DTCP command (X), the DTCP application assigns “D1” to a transmitter transmitting the DTCP command (X), and retains the transmitter as D1 and its IP address in memory (step S801).

Then, the DTCP application checks whether the received DTCP command (X) is used in a command process in which an authentication process is performed by sequential exchange of commands, and which is not a one-shot command process (step S802).

In the case where the received DTCP command (X) is used in the command process which is not the one-shot command process (Yes in step S802), a transmitter located within the scope limited by the TTL value is confirmed by the authentication process by sequential exchange of commands. Therefore, the DTCP application executes a process requested by the received DTCP command (X) (step S807). Then, after the requested process is executed, the DTCP application sends back a response to the DTCP command (X) to the transmitter D1 (step S808), and completes a routine of this process.

On the other hand, in the case where the received DTCP command (X) is used in the one-shot command process (No in step S802), the DTCP application checks whether the DTCP command (Y1) with a TTL value within the limit is transmitted to the transmitter D1 within a predetermined period T prior to reception of the DTCP command (X) (step S803).

In this case, in the case where the DTCP command (Y1) with a TTL value no greater than 3 is transmitted to the transmitter D1 within the predetermined period T (Yes in step S803), the DTCP application further checks whether a response to the DTCP command (Y1) is received from the transmitter D1 within a time-out period (step S804). In this case, whether a transmitter transmitting the response to the DTCP command (Y1) is the transmitter D1 is confirmed by Source IP address matching. Moreover, whether the response corresponds to the DTCP command (Y1) is confirmed by whether a command ID (subfunction) value written in DTCP command data of the DTCP command (Y1) matches a command ID value written in DTCP command data of the response.

In the case where the response to the DTCP command (Y1) is received from the transmitter D1 within the time-out period (Yes in step S804), it is confirmed that the transmitter D1 is located within the scope limited by the TTL value. Accordingly, the separate procedure for confirming whether the transmitter D1 is located within the scope limited by the TTL value is not necessary; therefore, the DTCP application executes a process requested by the received DTCP command (X) (step S807). Then, after the DTCP application executes the requested process, the DTCP application sends back a response to the DTCP command (X) to the transmitter D1 (step S808), and completes the routine of this process.

Moreover, in the case where the DTCP command (Y1) with a TTL value no greater than 3 is not transmitted to the transmitter D1 within the predetermined period T (No in step S803), or in the case where the response to the DTCP command (Y1) is not received from the transmitter D1 within the time-out period (No in step S804), it is confirmed that the received packet (X) is a to-be-confirmed packet. In this case, the separate process for confirming whether the transmitter D1 is located within the scope limited by the TTL value is necessary.

Therefore, the DTCP application transmits, as a confirmation packet, the DTCP command (Y2) or the PING which is used in a one-shot command process to the transmitter DI within the predetermined period T from reception of the DTCP command (X) (step S805). Then, the DTCP application checks whether a response to the confirmation packet, that is, the DTCP command (Y2) or the PING is received from the transmitter D1 within the time-out period (step S806). In this case, whether a transmitter transmitting the response to the DTCP command (Y2) or the PING is the transmitter D1 is confirmed by Source IP address matching.

In the case where the response to the DTCP command (Y2) or the PING is received from the transmitter D1 within the time-out period (Yes in step S806), it is confirmed that the transmitter D1 is located within the scope limited by the TTL value. In this case, the DTCP application executes the process requested by the received DTCP command (X) (step S807). Then, after the DTCP application executes the requested process, the DTCP application sends back a response to the DTCP command (X) to the transmitter D1 (step S808), and completes the routine of this process.

On the other hand, in the case where the response to the DTCP command (Y2) or the PING is not received from the transmitter D1 within the time-out period (No in step S806), it is confirmed that the transmitter D1 is not located within the scope limited by the TTL value. In this case, the DTCP application completes the routine of this process without executing the process requested by the received DTCP command (X) and without sending back the response to the DTCP command (X) to the transmitter D1.

Thus, in the embodiment, the DTCP device is allowed to confirm whether a transmitter transmitting a DTCP command is located within the scope limited by the TTL value by a procedure different from reception of the DTCP command. Therefore, even under en environment in which the value of the TTL field of the received IP packet is not allowed to be referenced, “discarding of a DTCP command with a TTL value greater than 3” requested in the DTCP specification is allowed to be executed, and a DTCP-compliant application is allowed to be implemented.

It is to be noted that the technology of the disclosure is allowed to have the following configurations.

(1) A communication apparatus including:
a communication section transmitting and receiving a packet encapsulating a command or a response;
a transmitter confirmation section confirming whether a transmitter transmitting a command is located within a scope limited by a time-to-live value without referencing a header of a received packet; and
a control section controlling a process requested by the received command or subsequent communication with the transmitter transmitting the command based on a confirmation result by the transmitter confirmation section.

(2) The communication apparatus according to (1), in which, when the communication section receives a command used in an authentication process by sequential exchange of commands, the transmitter confirmation section does not perform a process of confirming a transmitter transmitting the command.

(3) The communication apparatus according to (1), in which, when the communication section receives a command which is necessary to be confirmed, the transmitter confirmation section performs a process of confirming a transmitter transmitting the command, the command being used in a process completed with one command and being not involved in mutual exchange of commands.

(4) The communication apparatus according to (1), in which, when the communication section transmits, within a predetermined period prior to reception of a first command, a second command to a transmitter transmitting the first command, and receives a response to the second command before a time-out period expires, the transmitter confirmation section determines that the transmitter transmitting the first command is located within the scope limited by the time-to-live value.

(5) The communication apparatus according to (1), in which, when the communication section transmits, within a predetermined period from reception of a command, a confirmation packet with a time-to-live value set within a limit to a transmitter transmitting the command, and receives a response to the confirmation packet before a time-out period expires, the transmitter confirmation section determines that the transmitter transmitting the command is located within the scope limited by the time-to-live value.

(6) The communication apparatus according to (5), in which the communication section transmits a command or a PING as the confirmation packet, the command or the PING being used in a process completed with one command and being not involved in mutual exchange of commands.

(7) The communication apparatus according to (1), in which, when the transmitter confirmation section confirms, during content transmission to the transmitter transmitting the command, that the transmitter transmitting the command is not located within the scope limited by the time-to-live value, the control section stops the content transmission.

(8) The communication apparatus according to (1), in which, when the transmitter confirmation section confirms that the transmitter transmitting the command is located within the scope limited by the time-to-live value, the control section executes a process requested by the command.

(9) The communication apparatus according to (1), in which, when the transmitter confirmation section confirms that the transmitter transmitting the command is located within the scope limited by the time-to-live value, the control section executes a process requested by the command and sends back a response to the transmitter.

(10) A communication method including:
receiving a packet encapsulating a command;
performing confirmation whether a transmitter transmitting the command is located within a scope limited by a time-to-live value without referencing a header of the received packet; and
controlling a process requested by the received command or subsequent communication with the transmitter transmitting the command based on a result of the confirmation.

(11) A communication system including:
a first device setting a time-to-live value of a packet encapsulating a command to an arbitrary value, and transmitting the packet; and
a second device receiving the packet and performing confirmation whether the first device is located within a scope limited by the time-to-live value without referencing a header of the packet, and then performing a process requested by the received command based on a result of the confirmation.

(12) The communication system according to (11), further including an arbitrary number of routers each forwarding the packet while decrementing the time-to-live value by one,
in which the second device receives the packet through the routers.

(13) A non-transitory computer-readable medium storing a computer program written in a computer-readable format allowing a computer to execute:
transmitting and receiving a packet encapsulating a command or a response;
performing confirmation whether a transmitter transmitting a command is located within a scope limited by a time-to-live value without referencing a header of a received packet; and
controlling a process requested by the received command or subsequent communication with the transmitter transmitting the command based on a result of the confirmation.

The technology of the present disclosure is described in detail referring to specific embodiments. However, it is to be understood that modifications or alternatives to the embodiments could be made by those skilled in the art without departing from the scope of the technology of the present disclosure.

Herein, embodiments in which the technology of the present disclosure is applied to an IP network and a DTCP-compliant network are mainly described; however, the technology of the present disclosure is not limited thereto. The technology of the present disclosure is applicable to networks, other than the DTCP-compliant network, in which a limit is imposed on the TTL value, or a case where it is desired that a limit be imposed on the TTL value in a network not in accordance with an IP protocol.

Also, in a case where the technology of the present disclosure is applied under an environment in which the TTL value of the received packet is allowed to be confirmed, safe communication is allowed to be performed through confirming, by a separate procedure, whether the packet is transmitted from a transmitter located within the scope limited by the TTL value.

In summary, the present disclosure has been disclosed by way of exemplary embodiments, and the contents disclosed herein should not be restrictively construed. The scope of the present disclosure should be determined in consideration of the appended claims.

The present disclosure contains subject matter related to that disclosed in Japanese Priority Patent Application No. 2012-149948 filed in the Japan Patent Office on Jul. 3, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A communication apparatus comprising:
a communication section transmitting and receiving a packet encapsulating a command or a response;
a transmitter confirmation section confirming whether a transmitter transmitting a command is located within a scope limited by a time-to-live value without referencing a header of a received packet; and
a control section controlling a process requested by the received command or subsequent communication with the transmitter transmitting the command based on a confirmation result by the transmitter confirmation section.

2. The communication apparatus according to claim 1, wherein, when the communication section receives a command used in an authentication process by sequential exchange of commands, the transmitter confirmation section does not perform a process of confirming a transmitter transmitting the command.

3. The communication apparatus according to claim 1, wherein, when the communication section receives a command which is necessary to be confirmed, the transmitter confirmation section performs a process of confirming a transmitter transmitting the command, the command being used in a process completed with one command and being not involved in mutual exchange of commands.

4. The communication apparatus according to claim 1, wherein, when the communication section transmits, within a predetermined period prior to reception of a first command, a second command to a transmitter transmitting the first command, and receives a response to the second command before a time-out period expires, the transmitter confirmation section determines that the transmitter transmitting the first command is located within the scope limited by the time-to-live value.

5. The communication apparatus according to claim 1, wherein, when the communication section transmits, within a predetermined period from reception of a command, a confirmation packet with a time-to-live value set within a limit to a transmitter transmitting the command, and receives a response to the confirmation packet before a time-out period expires, the transmitter confirmation section determines that the transmitter transmitting the command is located within the scope limited by the time-to-live value.

6. The communication apparatus according to claim 5, wherein the communication section transmits a command or a PING as the confirmation packet, the command or the PING being used in a process completed with one command and being not involved in mutual exchange of commands.

7. The communication apparatus according to claim 1, wherein, when the transmitter confirmation section confirms, during content transmission to the transmitter transmitting the command, that the transmitter transmitting the command is not located within the scope limited by the time-to-live value, the control section stops the content transmission.

8. The communication apparatus according to claim 1, wherein, when the transmitter confirmation section confirms that the transmitter transmitting the command is located within the scope limited by the time-to-live value, the control section executes a process requested by the command.

9. The communication apparatus according to claim 1, wherein, when the transmitter confirmation section confirms that the transmitter transmitting the command is located within the scope limited by the time-to-live value, the control section executes a process requested by the command and sends back a response to the transmitter.

10. A communication method comprising:
receiving a packet encapsulating a command;
performing confirmation whether a transmitter transmitting the command is located within a scope limited by a time-to-live value without referencing a header of the received packet; and
controlling a process requested by the received command or subsequent communication with the transmitter transmitting the command based on a result of the confirmation.

11. A communication system comprising:
a first device setting a time-to-live value of a packet encapsulating a command to an arbitrary value, and transmitting the packet; and
a second device receiving the packet and performing confirmation whether the first device is located within a scope limited by the time-to-live value without referencing a header of the packet, and then performing a process requested by the received command based on a result of the confirmation.

12. The communication system according to claim 11, further comprising an arbitrary number of routers each forwarding the packet while decrementing the time-to-live value by one,
wherein the second device receives the packet through the routers.

13. A non-transitory computer-readable medium storing a computer program written in a computer-readable format allowing a computer to execute:
transmitting and receiving a packet encapsulating a command or a response;
performing confirmation whether a transmitter transmitting a command is located within a scope limited by a time-to-live value without referencing a header of a received packet; and
controlling a process requested by the received command or subsequent communication with the transmitter transmitting the command based on a result of the confirmation.
